(19) United States
(12) Patent Application Publication
(10) Pub. No.: US 2025/0277107 A1
(43) Pub. Date: Sep. 4, 2025

(54) PROPYLENE POLYMER COMPOSITIONS

(71) Applicant: Basell Poliolefine Italia S.r.l., Milano (IT)

(72) Inventors: Antonio Riemma, Ferrara (IT); Eleonora Ciaccia, Ferrara (IT); Marco Izzi, Frankfurt/M (DE); Marco Ciarafoni, Ferrara (IT); Alessia Di Capua, Ferrara (IT)

(73) Assignee: Basell Poliolefine Italia S.r.l., Milano (IT)

(21) Appl. No.: 18/286,465

(22) PCT Filed: Apr. 11, 2022
(86) PCT No.: PCT/EP2022/059642

§ 371 Date: Oct. 11, 2023

(30) Foreign Application Priority Data
Apr. 14, 2021 (EP) 21168430.3

(51) Int. Cl. C08L 23/12; B29C 48/00; B29C 48/08; B29C 71/02; B29K 23/00; B29L 7/00; C08L 23/16

(52) U.S. Cl. CPC C08L 23/12; B29C 48/022; B29C 48/08; B29C 71/02; C08L 23/16; B29K 2023/12; B29K 2023/16; B29K 2995/0018; B29K 2995/0077; B29L 2007/008; C08L 2201/10; C08L 2203/162; C08L 2205/025; C08L 2205/03

(57) ABSTRACT

Propylene polymer composition made from or containing:
A) from 30 wt % to 50 wt % of a propylene homopolymer having a melting point, measured by DSC, between 152° C. and 162° C.;
B) from 35 wt % to 55 wt % of a copolymer of propylene with ethylene containing from 2.5 wt % to 5.8 wt % of ethylene derived units, based upon the total weight of the propylene/ethylene copolymer; and
C) from 5 wt % to 24 wt % of a copolymer of propylene with ethylene containing from 6.0 wt % to 8.0 wt %, of ethylene derived units, based upon the total weight of the propylene/ethylene copolymer;
the sum of the amount of A, B, and C being 100 wt %.

### FIELD OF THE INVENTION

In general, the present disclosure relates to the field of chemistry. More specifically, the present disclosure relates to polymer chemistry. In particular, the present disclosure relates to a propylene polymer composition.

### BACKGROUND OF THE INVENTION

Isotactic polypropylene is used in a variety of applications.

In some instances, the properties of the isotactic polypropylene are improved by decreasing the crystallinity of the propylene homopolymer through copolymerizing the propylene with ethylene and/or α-olefins such as 1-butene, 1-pentene and 1-hexene. In some instances, the resulting copolymers are referred to as random crystalline propylene copolymers and demonstrate improved flexibility and transparency in comparison to the homopolymer.

In some instances, propylene random copolymers do not provide sufficient improvement in impact resistance when compared to the homopolymer, including at low temperatures.

In some instances, the impact resistance of polypropylene is improved by adding an elastomeric propylene-ethylene copolymer to the homopolymers by mechanical blending or sequential polymerization. In some instances, the improvement is detrimental to the material's transparency, including after a sterilization process.

### SUMMARY OF THE INVENTION

In a general embodiment, the present disclosure provides a propylene polymer composition made from or containing:
A) from 30 wt % to 50 wt % of a propylene homopolymer or a copolymer of propylene with ethylene containing up to 1.0 wt % of ethylene derived units, measured by NMR, based upon the total weight of the propylene/ethylene copolymer; having a melting point, measured by DSC, between 152° C. and 162° C.;
B) from 35 wt % to 55 wt % of a copolymer of propylene with ethylene containing from 2.5 wt % to 5.8 wt % of ethylene derived units, measured by NMR, based upon the total weight of the propylene/ethylene copolymer; and
C) from 5 wt % to 24 wt % of a copolymer of propylene with ethylene containing from 6.0 wt % to 8.0 wt % of ethylene derived units, measured by NMR, based upon the total weight of the propylene/ethylene copolymer;
the sum of the amount of A, B, and C being 100 wt %;
wherein the propylene polymer composition having
   a melt flow rate, (ISO 1133 (230° C., 2.16 kg), ranging from 0.5 g/10 min to 15.2 g/10 min;
   a xylene soluble fraction, measured at 25° C., ranging from 3.0 wt % to 8.0 wt %, based upon the total weight of the propylene polymer composition;
   a total content of ethylene derived units, measured by NMR, ranging from 2.0 wt % to 4.5 wt %, based upon the total weight of the propylene polymer composition;
   a content of ethylene derived units, measured by NMR, in the fraction soluble in xylene at 25° C. ranging from 18.2 wt % to 23.4 wt %, based upon the weight of soluble fraction; and
   a melting point, measured by DSC, ranging from 145° C. to 160° C.

### DETAILED DESCRIPTION OF THE INVENTION

In some embodiments, the present disclosure provides a propylene polymer composition made from or containing:
A) from 30 wt % to 50 wt %; alternatively from 35 wt % to 45 wt %; alternatively from 37 wt % to 43 wt %, of a propylene homopolymer or a copolymer of propylene with ethylene containing up to 1.0 wt %, alternatively up to 0.8 wt %, alternatively up to 0.6 wt %, of ethylene derived units, measured by NMR, based upon the total weight of the propylene/ethylene copolymer; having a melting point, measured by DSC, between 152° C. and 162° C.; alternatively between 155° C. and 161° C.; alternatively between 156° C. and 160° C.;
B) from 35 wt % to 55 wt %, alternatively from 40 wt % to 50 wt %, alternatively from 40 wt % and 47 wt %, of a copolymer of propylene with ethylene containing from 2.5 wt % to 5.8 wt %, alternatively from 3.5 wt % to 5.3 wt %, alternatively from 3.9 wt % to 4.9 wt %, of ethylene derived units, measured by NMR, based upon the total weight of the propylene/ethylene copolymer; and
C) from 5 wt % to 24 wt %, alternatively from 8 wt % to 18 wt %, alternatively from 12 wt % to 16 wt %, of a copolymer of propylene with ethylene containing from 6.0 wt % to 8.0 wt %, alternatively from 6.3 wt % to 7.8 wt %, of ethylene derived units; alternatively from 6.5 wt % to 7.3 wt %, based upon the total weight of the propylene/ethylene copolymer;
the sum of the amounts of A, B, and C being 100 wt %;
wherein the propylene polymer composition having
   a melt flow rate, (ISO 1133 (230° C., 2.16 kg), ranging from 0.5 g/10 min to 15.2 g/10 min, alternatively from 1.0 g/10 min to 15.2 g/10 min, alternatively from 4.2 g/10 min to 11.2 g/10 min, alternatively from 5.3 g/10 min to 8.4 g/10 min;
   a xylene soluble fraction, measured at 25° C., ranges from 3.0 wt % to 8.0 wt %, alternatively from 3.5 wt % to 7.5 wt %, alternatively from 4.2 wt % to 6.3 wt %, based upon the total weight of the propylene polymer composition;
   a total content of ethylene derived units, measured by NMR, ranging from 2.0 wt % to 4.5 wt %, ranging from 2.5 wt % to 4.2 wt %, alternatively from 2.7 wt % to 3.7 wt %, based upon the total weight of the propylene polymer composition;
   a content of ethylene derived units, measured by NMR, in the fraction soluble in xylene at 25° C. ranging from 18.2 wt % to 23.4 wt %; alternatively from 19.2 wt % to 22.4 wt %; alternatively from 19.8 wt % to 21.4 wt %, based upon the weight of the soluble fraction; and
   a melting point, measured by DSC, ranging from 145° C. to 160° C.; alternatively ranges from 147° C. to 159° C.; alternatively ranges from 148° C. to 158° C.

As used herein, the term “copolymer” refers to polymers containing propylene and ethylene, in the absence of other monomers.

In some embodiments, the propylene polymer composition has one or more of the following features:
a Tensile Modulus higher than 700 MPa;
a Haze, measured on 70 μm film after sterilization, lower than 12.0%, alternatively lower than 11.0%, alternatively lower than 10.5%;
a melting point and a seal initiation temperature (SIT), measured on a 70 μm, such that the difference between the melting point and the seal initiation temperature is higher than 15° C.; alternatively higher than 16° C.; or
   a hexane soluble fraction, measured on a film having a thickness of 100μ, ranging from 0.5 wt % to 2.2 wt %; alternatively from 0.7 wt % to 1.9 wt %; alternatively from 0.9 wt % to 1.6 wt %.

In some embodiments, component A) is obtainable by polymerizing propylene and optionally ethylene using various polymerization techniques. In some embodiments, the polymerization technique is a slurry polymerization using, as a diluent, an inert hydrocarbon solvent. In some embodiments, the polymerization technique is a bulk polymerization using the liquid monomer as a reaction medium. In some embodiments, the liquid monomer is propylene. In some embodiments, the polymerization process is carried out in gas-phase operating in one or more fluidized or mechanically agitated bed reactors.

In some embodiments, components B) and C) are obtainable by polymerizing propylene and ethylene using various polymerization techniques. In some embodiments, the polymerization technique is a slurry polymerization using, as a diluent, an inert hydrocarbon solvent. In some embodiments, the polymerization technique is a bulk polymerization using the liquid monomer as a reaction medium. In some embodiments, the liquid monomer is propylene. In some embodiments, the polymerization process is carried out in gas-phase operating in one or more fluidized or mechanically agitated bed reactors.

In some embodiments, the polymerization process to obtain components A), B) and C) is carried out at temperatures of from 20 to 120° C., alternatively from 40 to 80° C. In some embodiments, the polymerization is carried out in gas-phase with an operating pressure between 0.5 and 5 MPa, alternatively between 1 and 4 MPa. In some embodiments, the polymerization is carried out in bulk polymerization with an operating pressure between 1 and 8 MPa, alternatively between 1.5 and 5 MPa. In some embodiments, hydrogen is used as a molecular weight regulator.

In some embodiments, components A), B) and C) are prepared and then blended together. In some embodiments, components A), B) and C) are prepared in series. In some embodiments, (i) component A) is prepared in a loop reactor in bulk by using propylene as reaction medium, (ii) component A) is fed to a second loop, (iii) component B) is prepared in the second loop and in bulk by using propylene as reaction medium, (iv) the reaction product made from or containing components A) and B) is fed to a gas phase reactor, and (v) component C) is prepared in the gas-phase reactor, thereby yielding the propylene polymer composition made from or containing components A), B), and C).

In some embodiments, the polymerizations are carried out in the presence of Ziegler-Natta catalysts. The catalysts are made from or containing a solid catalyst component made from or containing a titanium compound having a titanium-halogen bond and an electron-donor compound. The titanium compound and the electron-donor compound are supported on a magnesium halide in active form. The Ziegler-Natta catalysts are used with an organoaluminium compound as a cocatalyst. In some embodiments, the organoaluminum compound is an aluminum alkyl compound.

An external donor is optionally added.

In some embodiments, the catalysts yield a polypropylene homopolymer with a value of xylene insolubility at ambient temperature greater than 90%, alternatively greater than 95%.

In some embodiments, the catalysts are as described in U.S. Pat. No. 4,399,054 and European Patent No. 45977. In some embodiments, the catalysts are as described in U.S. Pat. No. 4,472,524.

In some embodiments, the solid catalyst components, used electron-donors (internal donors), are selected from the group consisting of ethers, ketones, lactones, compounds containing N, P and/or S atoms, and esters of mono- and dicarboxylic acids.

In some embodiments, the electron-donor compounds are esters of phthalic acid and 1,3-diethers of formula:

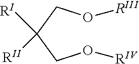

wherein R^{I} and R^{II} are the same or different and are C₁-C₁₈ alkyl, C₃-C₁₈ cycloalkyl, or C₇-C₁₈ aryl radicals; R^{III} and R^{IV} are the same or different and are C₁-C₄ alkyl radicals; or are the 1,3-diethers wherein the carbon atom in position 2 belongs to a cyclic or polycyclic structure made up of 5, 6, or 7 carbon atoms, or of 5-n or 6-n′ carbon atoms, and respectively n nitrogen atoms and n′ heteroatoms selected from the group consisting of N, O, S, and Si, where n is 1 or 2 and n′ is 1, 2, or 3, the structure containing two or three unsaturations (cyclopolyenic structure), and optionally being condensed with other cyclic structures, or substituted with one or more substituents selected from the group consisting of linear or branched alkyl radicals; cycloalkyl, aryl, aralkyl, alkaryl radicals, and halogens, or being condensed with other cyclic structures and substituted with one or more of the above-mentioned substituents; one or more of the above-mentioned alkyl, cycloalkyl, aryl, aralkyl, or alkaryl radicals and the condensed cyclic structures optionally containing one or more heteroatom(s) as substitutes for carbon or hydrogen atoms, or both. In some embodiments, the substituents are bonded to the condensed cyclic structures.

In some embodiments, the ethers are selected from the ethers described in European Patent Application Nos. 361493 and 728769.

In some embodiments, the diethers are selected from the group consisting of 2-methyl-2-isopropyl-1,3-dimethoxypropane, 2,2-diisobutyl-1,3-dimethoxypropane, 2-isopropyl-2-cyclopentyl-1,3-dimethoxypropane, 2-isopropyl-2-isoamyl-1,3-dimethoxypropane, and 9,9-bis(methoxymethyl) fluorene.

In some embodiments, the electron-donor compounds are phthalic acid esters. In some embodiments, the phthalic acid esters are selected from the group consisting of diisobutyl phthalate, dioctyl phthalate, diphenyl phthalate, and benzylbutyl phthalate.

In some embodiments, the Al-alkyl compounds, used as co-catalysts, are selected from the group consisting of Al-trialkyls and linear or cyclic Al-alkyl compounds containing two or more Al atoms bonded to each other by way of O or N atoms, or SO₄ or SO₃ groups. In some embodiments, the Al-trialkyls are selected from the group consisting of Al-triethyl, Al-triisobutyl, and Al-tri-n-butyl.

In some embodiments, the Al-alkyl compound is used in an amount such that the Al/Ti ratio is from 1 to 1000.

In some embodiments, the electron-donor compounds, used as external donors, are selected from the group consisting of aromatic acid esters and silicon compounds containing at least one Si—OR bond, where R is a hydrocarbon radical. In some embodiments, the aromatic acid esters are alkyl benzoates.

In some embodiments, the silicon compounds are selected from the group consisting of (tert-butyl)₂Si(OCH₃)₂, (cyclohexyl)(methyl)Si(OCH₃)₂, (cyclopentyl)₂Si(OCH₃)₂, (phenyl)₂Si(OCH₃)₂, and (1,1,2-trimethylpropyl)Si(OCH₃)₃.

In some embodiments, the internal donor is 1,3-diether and the external donors are omitted.

In some embodiments, the terpolymers are prepared by using catalysts containing a phthalate as internal donor and (cyclopentyl)₂Si(OCH₃)₂ as external donor. In some embodiments, the terpolymers are prepared by using catalysts containing 1,3-diethers as internal donors.

In some embodiments, the catalyst system is made from or containing (a) a solid catalyst component, having an average particle size ranging from 15 to 80 μm, made from or containing a magnesium halide, a titanium compound having at least a Ti-halogen bond, and at least two electron donor compounds, wherein the first electron donor compound is present in an amount from 40 to 90% by mol with respect to the total amount of donors and selected from succinates and the second electron donor compound is selected from 1,3 diethers, (b) an aluminum hydrocarbyl compound, and optionally (c) an external electron donor compound.

In some embodiments, the molecular weight is regulated. In some embodiments, the regulator is hydrogen.

It is believed that the concentration of the molecular weight regulator in certain steps affects the MFR and [η] values.

In some embodiments, the catalysts are pre-contacted with small amounts of olefins (prepolymerization).

In some embodiments, the propylene polymer compositions are obtained by preparing separately the components A), B), and C) in a non-wholly sequential polymerization process, wherein the components and fractions are prepared in separate polymerization steps and mechanically blended while the components and fractions are in a molten or softened state. In some embodiments, the mechanical blended is achieved with screw extruders, alternatively twin screw extruders.

In some embodiments, the propylene polymer compositions are further made from or containing additives. In some embodiments, the additives are selected from the group consisting of antioxidants, light stabilizers, heat stabilizers, nucleating agents, colorants, and fillers.

In some embodiments, nucleating agents improve physical-mechanical properties. In some embodiments, the physical-mechanical properties are selected from the group consisting of Flexural Modulus, Heat Distortion Temperature (HDT), tensile strength at yield, and transparency.

In some embodiments, the nucleating agents are selected from the group consisting of p-tert.-butyl benzoate, 1,3-dibenzylidenesorbitol, and 2,4-dibenzylidenesorbitol.

In some embodiments, the nucleating agents are added to the propylene polymer compositions in quantities ranging from 0.05 to 2% by weight, alternatively from 0.1 to 1% by weight, with respect to the total weight.

In some embodiments, the propylene polymer compositions are further made from or containing inorganic fillers. In some embodiments, the inorganic fillers are selected from the group consisting of talc, calcium carbonate, and mineral fibers. In some embodiments, inorganic fillers improve mechanical properties. In some embodiments, the mechanical properties are selected from the group consisting of Flexural Modulus and HDT. In some embodiments, talc has a nucleating effect.

In some embodiments, the melt flow rate of the propylene polymer composition is adjusted by visbreaking. In some embodiments, visbreaking achieved with peroxides.

In some embodiments, the present disclosure provides a film made from or containing the propylene polymer composition. In some embodiments, the films are selected from the group consisting of BOPP films, blow films, and cast films mono and multilayer. In some embodiments, the films are cast films. In some embodiments, the films are sterilized. In some embodiments, the films are multilayer films, alternatively multilayer sterilizable films.

In some embodiments, the present disclosure provides retortable pouches made from or containing the propylene polymer composition. As used herein, the term “retortable pouches” refers to multi-material laminated packages sterilized to preserve food contained within the packages, after being sealed. In some embodiments, the melting point and the SIT of the propylene polymer composition allow the preparation of recyclable, mono material packaging.

In some embodiments, the sterilization is carried out at temperatures higher than 120° C. but lower than the melting point of the propylene polymer composition.

The following examples are given to illustrate, without limiting, the present disclosure.

### EXAMPLES

### Melt Flow Rate

Determined according to ISO 1133 (230° C., 2.16 kg).

### ¹³C NMR of Propylene/Ethylene Copolymers

¹³C NMR spectra were acquired on a Bruker AV-600 spectrometer equipped with cryoprobe, operating at 160.91 MHz in the Fourier transform mode at 120° C.

The peak of the SBB carbon (nomenclature according to “Monomer Sequence Distribution in Ethylene-Propylene Rubber Measured by 13C NMR. 3. Use of Reaction Probability Mode” C. J. Carman, R. A. Harrington and C. E. Wilkes, Macromolecules, 1977, 10, 536) was used as internal standard at 29.9 ppm. The samples were dissolved in 1,1,2,2-tetrachloroethane-d2 at 120° C. with an 8% wt/v concentration. Each spectrum was acquired with a 90° pulse, 15 seconds of delay between pulses and CPD, thereby removing 1H-13C coupling. 512 transients were stored in 32K data points using a spectral window of 9000 Hz.

The assignments of the spectra, the evaluation of triad distribution, and the composition were made according to Kakugo (“Carbon-13 NMR determination of monomer sequence distribution in ethylene-propylene copolymers prepared with 8-titanium trichloride-diethylaluminum chloride” M. Kakugo, Y. Naito, K. Mizunuma and T. Miyatake, Macromolecules, 1982, 15, 1150) using the following equations:

$$PPP = 100 {T}_{ββ} / S \qquad PPE = 100 {T}_{βδ} / S \qquad EPE = 100 {T}_{δδ} / S$$

$$PEP = 100 {S}_{ββ} / S \qquad PEE = 100 {S}_{βδ} / S \qquad EEE = 100 ( 0.25 {S}_{γδ} + 0.5 {S}_{δδ} ) / S$$

$$S = {T}_{ββ} + {T}_{βδ} + {T}_{δδ} + {S}_{ββ} + {S}_{βδ} + 0.25 {S}_{γδ} + 0.5 {S}_{δδ}$$

The molar percentage of ethylene content was evaluated using the following equation:

$$E \% mol = 100 * [ PEP + PEE + EEE ]$$

The weight percentage of ethylene content was evaluated using the following equation:

$$E \% wt . = \frac{* E \% mol * {MW}_{E}}{E \% mol * {MW}_{E +} P \% mol * {MW}_{P}}$$

where P % mol is the molar percentage of propylene content, while MW_{E} and MW_{P} are the molecular weights of ethylene and propylene, respectively.

The product of reactivity ratio r₁/r₂ was calculated according to Carman (C. J. Carman, R. A. Harrington and C. E. Wilkes, Macromolecules, 1977; 10, 536) as:

$${r}_{1} {r}_{2} = 1 + ( \frac{EEE + PEE}{PEP} + 1 ) - ( \frac{P}{E} + 1 ) {( \frac{EEE + PEE}{PEP} + 1 )}^{0.5}$$

The tacticity of Propylene sequences was calculated as mm content from the ratio of the PPP mm T_{ββ} (28.90-29.65 ppm) and the whole T_{ββ} (29.80-28.37 ppm)

The amount of ethylene derived units of components B) and C) were calculated by using the following formula

C₂ₜₒₜ=C_{2A}*A+C_{2B}*B+C_{2C}*C

wherein C₂ₜₒₜ is the amount of ethylene derived units in the composition; C_{2A} is the amount of ethylene derived units in component A); C_{2B} is the amount of ethylene derived units in component B); C_{2C} is the amount of ethylene derived units in component C); and A, B and C are the amounts of components A), B) and C) wherein A+B+C=1.

### Seal Initiation Temperature (SIT)

### Preparation of the Film Specimens

Cast films were prepared by extruding each test composition in a single screw Collin cast film extruder, equipped with a three-layer co-extrusion cast film line (main extruder screw diameter 45 mm, L/D 30; two side extruders screw diameter 30 mm, L/D 30) at a melt temperature of 190-250° C.

The cast film was produced with a nominal thickness of 70 μm, which was the final specimen thickness. Some films were produced with a nominal thickness of 50 μm.

Some films with a thickness of 50 μm were prepared by extruding the test composition in a single screw Collin extruder (length/diameter ratio of screw 1:25) at a film drawing speed of 7 m/min and a melt temperature of 210-250° C. Each resulting film was superimposed on a 1000 μm thick film of a propylene homopolymer, having a xylene insoluble fraction of 97 wt % and a MFR L of 2 g/10 min. The superimposed films were bonded to each other in a Carver press at 200° C. under a 9000 kg load, which was maintained for 5 minutes. The resulting laminates were stretched longitudinally and transversally, that is, biaxially, by a factor 6 with a TOM Long film stretcher at 150° C., thereby obtaining a 20 μm thick film (18 μm homopolymer+2 μm test). 2×5 cm specimens were cut from the films.

### Determination of the SIT.

Seal strength was measured according to ASTM F2029-16 and ASTM F88-15. By plotting the seal strength versus the sealing temperature, a sealing curve was produced. SIT on cast film was determined as the temperature at the sealing force that corresponds to the half-height of the plateau of the sealing curve (plateau defined as D F≤3N).
Tensile Modulus was measured according to ISO 527-2, and ISO 1873-2 on injection-molded sample.
Flexural Modulus was measure according to ISO 178, and supplemental conditions according to ISO 1873-2 on injection-molded sample.

### Haze

### Preparation of the Film Specimens

A film was prepared by extruding the polymer in a single screw Collin extruder (length/diameter ratio of screw: 25) at a film drawing speed of 7 m/min. and a melt temperature of 210-250° C.

Determined on cast films of the test composition. The measurement was carried out on a 50×50 mm portion cut from the central zone of the film.

The instrument used for the test was a Gardner photometer with Haze-meter UX-10 equipped with a G.E. 1209 lamp and filter C. The instrument calibration was made by carrying out a measurement in the absence of the sample (0% Haze) and a measurement with intercepted light beam (100% Haze).

### Melting Temperature, Melting Enthalpy and Crystallization Temperature

Determined by differential scanning calorimetry (DSC). A sample weighing 6±1 mg, was heated to 220±1° C. at a rate of 20° C./min and kept at 220±1° C. for 2 minutes in nitrogen stream. The sample was cooled at a rate of 20° C./min to 40±2° C. and maintained at this temperature for 2 min, thereby crystallizing the sample. Then, the sample was again fused at a temperature rise rate of 20° C./min up to 220±1° C. The melting scan was recorded. A thermogram was obtained. The melting temperatures were read.

### Solubility in Xylene at 25° C.

Xylene Solubles were measured according to ISO 16 152-2005; with solution volume of 250 ml, precipitation at 25° C. for 20 minutes, 10 minutes of which with the solution in agitation (magnetic stirrer), and with drying at 70°.

### Hexane Extractable on 100 μm Film

Determined according to FDA 177, 1520 by suspending the sample in an excess of hexane. The film was prepared by extrusion. The suspension was put in an autoclave at 50° C. for 2 hours. The hexane was removed by evaporation. The dried residue was weighed.

### Example 1

### Preparation of the Solid Catalyst Component

The catalyst system has been prepared according to example 1 of EP728769. Dicyclopentyldimethoxysilane (Donor-D) was used as external donor.

### Polymerization

The polymerization run was carried out in continuous mode in a series of three reactors equipped with devices to transfer the product from each reactor to the subsequent reactor. The first and second reactors were liquid, phase-loop reactors. The third reactor was a fluidized-bed, gas-phase reactor. Components A) and B) were prepared in the loop reactors while component C) was prepared in the gas-phase reactor. Hydrogen was used as a molecular weight regulator. The gas phase (propylene, ethylene, and hydrogen) was continuously analyzed via gas-chromatography. At the end of the run, the powder was discharged and dried under a nitrogen flow.

The main polymerization conditions and the analytical data relating to the polymers produced in the three reactors are reported in Table 1. Properties of the polymer are reported in Table 4.

TABLE 1

| PROCESS CONDITIONS | Ex. 1 |
|---|---|
| Precontact | |
| Temperature ° C. | 12 |
| Residence time (min) | 15 |
| Teal/donor ratio | 3 |
| Prepolymerization | |
| Temperature ° C. | 20 |
| Residence time (min) | 8 |
| Loop 1^{st} reactor in liquid | |
| phase - component A) | |
| Temperature, ° C. | 67 |
| Pressure, bar | 40 |
| Residence time, min | 50 |
| H2 feed, mol ppm | 340 |
| Split, wt % | 40 |
| Loop 2^{nd} reactor in liquid | |
| phase - component B) | |
| Temperature, ° C. | 67 |
| Pressure, bar | 40 |
| Residence time, min | 45 |
| H2 feed, mol ppm | 550 |
| C2 feed, kg/h | 10 |
| Split, wt % | 45 |
| Gas-Phase reactor - | |
| component C) | |
| Temperature, ° C. | 80 |
| Pressure, bar | 18 |
| Residence time, min | 30 |
| H2/C3, mol/mol | 0.005 |
| H2/C2, mol/mol | 0.103 |
| C2/C2 + C3, mol/mol | 0.05 |
| Split, wt % | 15 |

TABLE 2

| | | Ex 1 |
|---|---|---|
| Component A) | | |
| C2 content,* | wt % | <0.5 |
| Split | — | 41% |
| Tₘ DSC | ° C. | 158.7 |
| Component B) | | |
| Split stage | — | 45% |
| C2 component B) ** | wt % | 4.5 |
| Component C) | | |
| MFR | dg/min | 0.95 |
| Split stage | % | 14% |
| C2 component C) ** | wt % | 6.9 |

*A small amount of ethylene would pass from the second reactor to the first reactor even when there was no ethylene added to the first reactor.
** calculated C2 = ethylene derived units

The polymer of example 1 was further made from or containing the additives reported in Table 3 and visbroken.

TABLE 3

| | | |
|---|---|---|
| Irganox 1010 | wt % | 0.05 |
| Irgafos 168 | wt % | 0.10 |
| Ca Stearate | wt % | 0.05 |
| Peroxan | wt % | 0.03 |

Properties of the polymer obtained after visbreaking are reported on Table 4.

TABLE 4

| | | |
|---|---|---|
| MFR | dg/min | 6.7 |
| Xylene Soluble | wt % | 5.8 |
| C2 content, NMR | wt % | 3.1 |
| C2-XS content, NMR | wt % | 20.9 |
| Tₘ DSC | ° C. | 150.4 |
| T_{c} DSC | ° C. | 105.6 |
| Hexane extractables | wt % | 1.3 |
| (100 mm film) | | |
| Tensile Modulus | MPa | 910 |
| Stress at yield | MPa | 25.3 |
| Elongation at yield | % | 13.6 |
| Stress at break | MPa | 28.2 |
| Elongation at break | % | 590 |
| Charpy @ +23° C. | kJ/m2 | 8.1 |
| Charpy @ 0° C. | kJ/m2 | 2.3 |

The product of Table 4 was used to prepared cast films having thicknesses of 50 μm and 70 μm. The properties of the film are reported in Table 5.

TABLE 5

| Cast Film | | 50 μm | 70 μm |
|---|---|---|---|
| SIT, Sealing curve | ° C. | 132 | 133 |
| half-plateau T | | | |
| Δ(Tₘ-SIT) | ° C. | 18 | 17 |
| Seal strength | N/15 mm | — | 30.3 |
| Seal strength | N/15 mm | — | 32.5 |
| after retorting | | | |
| @135° C. 45′ | | | |
| Tensile Modulus, MD | MPa | 413 | 468 |
| Stress at yield, MD | MPa | 17.0 | 17.6 |
| Elongation at | % | 14.6 | 14.2 |
| yield, MD | | | |
| Haze | % | 0.24 | 1.16 |
| Haze, after | % | — | 9.1 |
| sterilization | | | |

The haze of the films of example 1 are compared in Table 6 with the haze reported for a 50 mm film of the polymer of example 1 of Patent Cooperation Treaty Publication No. WO2013/135654 (comparative example 3).

TABLE 6

| | 1 | 1 | Comp 3 |
|---|---|---|---|
| Ex | (50 μm) | (70 μm) | (50 μm) |
| Haze % | 0.24 | 1.16 | 2.4 |
| Haze, after | — | 9.1 | 15.5 |
| sterilization % | | | |

### Sterilization Procedure

The sample was placed in a steam sterilization autoclave Systec DX-65 set at 121° C. and 2.1 bar of nitrogen internal pressure. After 20 minutes of treatment in the autoclave, the item was allowed to cool to room temperature and conditioned at room temperature for 48 hours before testing.

1. A propylene polymer composition comprising:
A) from 30 wt % to 50 wt % of a propylene homopolymer or a copolymer of propylene with ethylene, containing up to 1.0 wt %, of ethylene derived units, measured by NMR, based upon the total weight of the propylene/ethylene copolymer; having a melting point, measured by DSC, between 152° C. and 162° C.;
B) from 35 wt % to 55 wt %, of a copolymer of propylene with ethylene, containing from 2.5 wt % to 5.8 wt %, of ethylene derived units, measured by NMR, based upon the total weight of the propylene/ethylene copolymer; and
C) from 5 wt % to 24 wt %, of a copolymer of propylene with ethylene, containing from 6.0 wt % to 8.0 wt %, of ethylene derived units, based upon the total weight of the propylene/ethylene copolymer;
the sum of the amount of A, B and C being 100 wt %;
wherein the propylene polymer composition having
a melt flow rate, (ISO 1133 (230° C., 2.16 kg, ranging from −0.5 g/10 min to −15.2 g/10 min;
a xylene soluble fraction, measured at 25° C., ranging from 3.0 wt % to 8.0 wt %, based upon the total weight of the propylene polymer composition;
a total content of ethylene derived units, measured by NMR, ranging from 2.0 wt % to 4.5 wt %, based upon the total weight of the propylene polymer composition;
a content of ethylene derived units, measured by NMR, in the fraction soluble in xylene at 25° C. ranging from 18.2 wt % to 23.4 wt %, based upon the weight of soluble fraction; and
a melting point, measured by DSC, ranging from 145° C. to 160° C.

2. The propylene polymer composition according to claim 1, wherein:
component A) ranges from 35 wt % to 45 wt %;
component B) ranges from 40 wt to 50 wt %; and
component C) ranges from 8 wt % to 18 wt %.

3. The propylene polymer composition according to claim 1, wherein component B) contains from 3.5 wt % to 5.3 wt % of ethylene derived units.

4. The propylene polymer composition according to claim 1, wherein component C) contains from 6.3 wt % to 7.8 wt % of ethylene derived units.

5. The propylene polymer composition according to claim 1, wherein the xylene soluble fraction measured at 25° C. ranges from 3.5 wt % to 7.5 wt %.

6. The propylene polymer composition according to claim 1, wherein the total content of ethylene derived units ranges from 2.5 wt % to 4.2 wt %.

7. The propylene polymer composition according to claim 1, wherein the content of ethylene derived units in the fraction soluble in xylene at 25° C. ranges from 19.2 wt % to 22.4 wt %.

8. The propylene polymer composition according to claim 1, wherein the melting point ranges from 147° C. to 159° C.

9. (canceled)

10. The propylene polymer composition according to claim 1, wherein the melt flow rate ranges from −4.2 g/10 min to −11.2 g/10 min.

11. The propylene polymer composition according to claim 1, having a hexane soluble fraction, measured on a film having a thickness of 100μ, ranging from 0.5 wt % to 2.2 wt %.

12. The propylene polymer composition according to claim 11, wherein the hexane soluble fraction ranges from 0.7 wt % to 1.9 wt %.

13. A film comprising the propylene polymer composition of claim 1.

14. The film according to claim 13, wherein the film is a cast film.

15. The film according to claim 13, wherein the film is a sterilized cast film.
